(19) United States
(12) Patent Application Publication
(10) Pub. No.: US 2015/0268789 A1
(43) Pub. Date: Sep. 24, 2015

(54) METHOD FOR PREVENTING ACCIDENTALLY TRIGGERING EDGE SWIPE GESTURE AND GESTURE TRIGGERING

(71) Applicant: PIXART IMAGING INC., HSIN-CHU COUNTY (TW)

(72) Inventors: CHI-CHIEH LIAO, HSIN-CHU COUNTY (TW); TSE-CHUNG SU, HSIN-CHU COUNTY (TW); MING-HUNG TSAI, HSIN-CHU COUNTY (TW)

(21) Appl. No.: 14/603,672

(22) Filed: Jan. 23, 2015

(30) Foreign Application Priority Data
Mar. 18, 2014 (TW) 103110234

(51) Int. Cl. G06F 3/041; G06F 3/0488

(52) U.S. Cl. CPC G06F 3/0416; G06F 3/0488; G06F 2203/04808

(57) ABSTRACT

There is provided a method for preventing accidentally triggering edge swipe gestures adapted to a touch control system including a touch surface. The method includes the steps of: recording first information when a first gesture is detected to end at a periphery of the touch surface; recording second information when a second gesture is detected to start at the periphery of the touch surface; and determining, by a processor, whether to trigger an edge swipe gesture of the touch control system according to the first information and the second information.

### RELATED APPLICATIONS

The present application is based on and claims priority to Taiwanese Application Number 103110234, filed Mar. 18, 2014, the disclosure of which is hereby incorporated by reference herein in its entirety.

### BACKGROUND

1. Field of the Disclosure

This disclosure generally relates to a triggering method by gestures and, more particularly, to a method for preventing accidentally triggering edge swipe gestures.

2. Description of the Related Art

The conventional touch control system, such as a touch pad, generally has a touch surface and a processing unit. When a user moves his/her finger on the touch surface, the processing unit calculates a position of the finger corresponding to the touch surface and generates a displacement signal. Then, the processing unit outputs the displacement signal to a host and correspondingly controls a cursor movement of the host.

With the popularity of the touch control system, a displacement signal generated according to a movement of an object with respect to a touch surface is not only configured to control a cursor movement but configured to implement the application of touch gestures. That is to say, a user may implement different functions, e.g. print screen, scrolling window, zoom in/out, calling a menu out or activating other applications, through different touch gestures. Accordingly, user experience is improved.

An edge swipe gesture is a kind of common touch gestures. A user moves a finger from an edge of a touch surface toward a center of the touch surface to trigger the edge wipe gesture. For example, the user calls out an application menu through the edge swipe gesture in Microsoft Windows 8; and the user calls out a pull down menu through the edge swipe gesture in Google Android.

FIG. 1 is a schematic diagram of triggering an edge swipe gesture, wherein a user moves a finger 8 on a touch area 9 of a touch control system to generate a displacement signal. When the finger 8 enters from outside of the touch area 9 into the touch area 9, as shown as a trace 8a in FIG. 1, an edge swipe gesture is then triggered by the touch control system. However, preventing accidentally triggering edge swipe gestures is preferred during some operations.

### SUMMARY

Accordingly, the present disclosure provides a method for preventing accidentally triggering edge swipe gestures and triggering methods by gestures.

The present disclosure provides a method for preventing accidentally triggering edge swipe gestures that determines whether to prevent triggering an edge swipe gesture according to at least one of a time difference between an object leaving and entering a touch surface via a periphery, and a distance between positions of the object leaving and entering the touch surface via the periphery.

The present disclosure further provides a method for preventing accidentally triggering edge swipe gestures and triggering methods by gestures that provide a better user experience.

The present disclosure provides a method for preventing accidentally triggering edge swipe gestures adapted to a touch control system having a touch surface. T he method includes the steps of: recording first information when a first gesture is detected to end at a periphery of the touch surface; recording second information when a second gesture is detected to start at the periphery of the touch surface; and determining, by a processor, whether to trigger an edge swipe gesture according to the first information and the second information, wherein the first gesture occurs previous to the second gesture.

The present disclosure further provides a triggering method by gestures adapted to a window system having an operation area. T he triggering method includes the steps of: detecting a first gesture in contact with a periphery of the operation area: detecting whether there is a second gesture in contact with the periphery within a predetermined time after the first gesture leaves the operation area from the periphery; and generating a first control command corresponding to the first gesture when the second gesture is not detected within the predetermined time, wherein the first gesture occurs previous to the second gesture.

The present disclosure further provides a triggering method by gestures adapted to a window system having an operation area. The triggering method includes the steps of: detecting an edge swipe gesture in contact with a periphery of the operation area; and generating an edge swipe control command when there is no gesture in contact with the periphery within a predetermined time before the edge swipe gesture contacts the periphery.

In one embodiment, the processor determines whether to trigger an edge swipe gesture according to a time difference between a first time and a second time.

In one embodiment. the processor determines whether to trigger an edge swipe gesture according to a time difference between a first time and a second time and a distance between a first position and a second position.

In one embodiment, the processor determines whether to trigger an edge swipe gesture according to a count stop signal when the processor identifies an object entering a touch surface through a periphery.

In one embodiment, the processor determines whether to trigger an edge swipe gesture according to a count stop signal and a distance between positions at a periphery where an object leaves and enters a touch surface.

In one embodiment, the processor generates a first control command corresponding to a first gesture or combines the first gesture with a second gesture to generate a combined control command according to whether there is the second gesture in contact with a periphery within a predetermined time after the first gesture leaves an operation area via the periphery.

In one embodiment. the processor generates an edge swipe control command or performs gestures combination without generating the edge swipe control command according to whether another gesture in contact with a periphery is detected within a predetermined time before an edge swipe gesture contacts the periphery.

The triggering method by gestures according to the embodiment of the present disclosure determines whether to trigger an edge swipe gesture through recording a time difference between an object leaving and entering a touch surface via a periphery. In addition, a touch control system using the same further records a distance between positions of the object leaving and entering the touch surface via the periphery to determine whether to trigger the edge swipe gesture so as to accordingly improve the accuracy for preventing accidentally triggering edge swipe gestures.

### BRIEF DESCRIPTION OF THE DRAWINGS

Other objects, advantages, and novel features of the present disclosure will become more apparent from the following detailed description when taken in conjunction with the accompanying drawings.

FIG. 1 is a schematic diagram of triggering an edge swipe gesture,

FIG. 2A is a schematic diagram of a touch control system for preventing accidentally triggering edge swipe gestures according to a first embodiment of the present disclosure.

FIG. 2B is a flow chart of a method for preventing accidentally triggering edge swipe gestures according to the first embodiment of the present disclosure.

FIG. 3 is triggering conditions of an edge swipe gesture according to a second aspect of the first embodiment of the present disclosure,

FIG. 4A is a schematic diagram of an object operating on a circular touch surface.

FIG. 4B is a schematic diagram of an object operating on a rectangular touch surface.

FIG. 5 is a block diagram of a touch control system for preventing accidentally triggering edge swipe gestures according to a second embodiment of the present disclosure.

FIG. 6 is a flow chart of a method for preventing accidentally triggering edge swipe gestures according to the second embodiment of the present disclosure.

FIG. 7 is a flow chart of a triggering method by gestures according to a third embodiment of the present disclosure.

FIG. 8 is a flow chart of a method for triggering edge swipe gestures according to a fourth embodiment of the present disclosure.

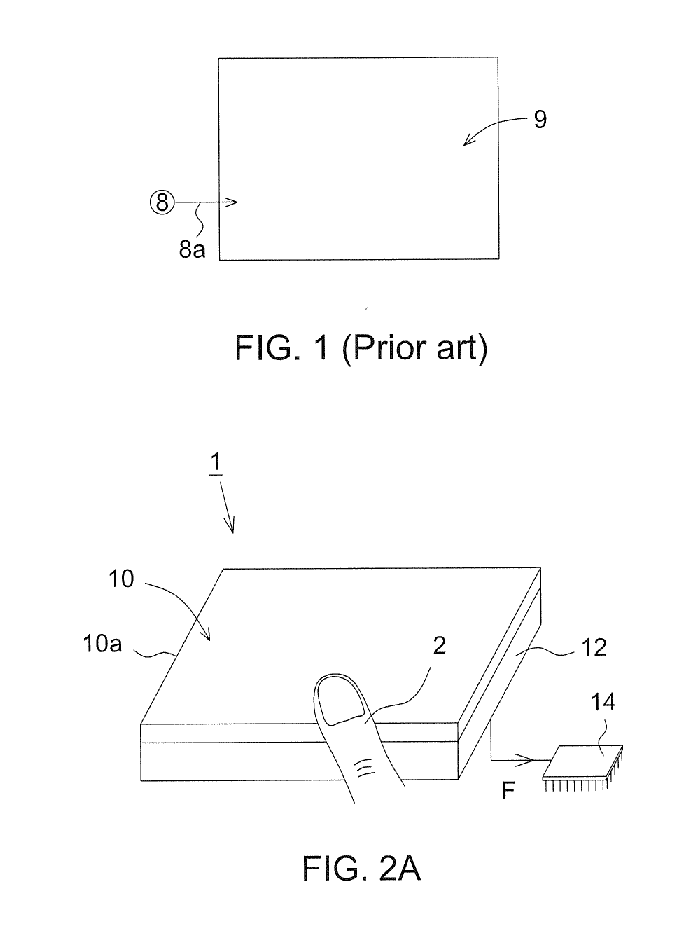

### DETAILED DESCRIPTION OF THE EMBODIMENT

It should be noted that, wherever possible, the same reference numbers will be used throughout the drawings to refer to the same or like parts.

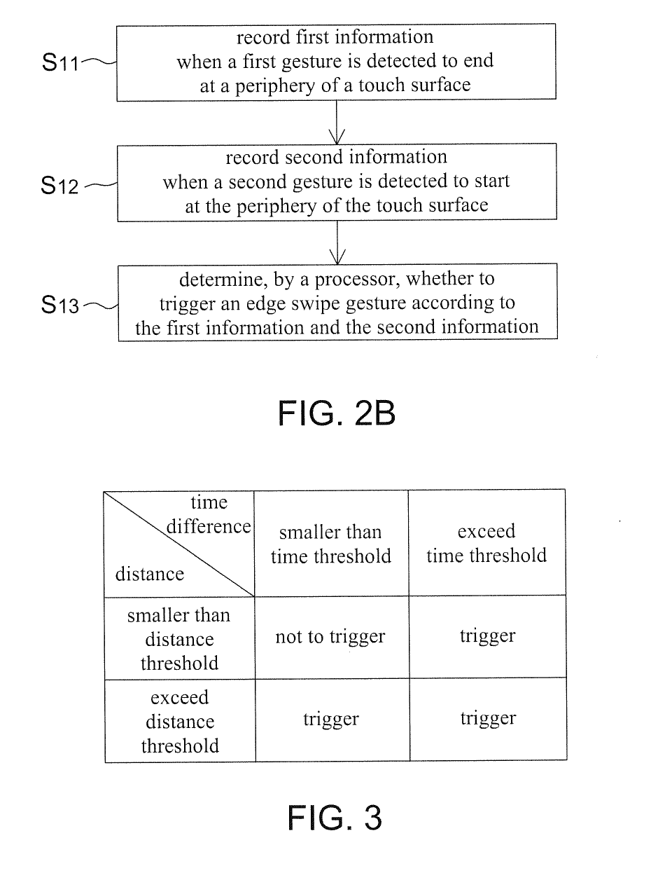

FIG. 2A is a schematic diagram of a touch control system 1 for preventing accidentally triggering edge swipe gestures according to a first embodiment of the present disclosure. The touch control system 1 includes a touch surface 10, a sensor 12 and a processor 14. The sensor 12 is electrically connected to the processor 14. A user touches or approaches the touch surface 10 with an object 2 (a finger shown herein), and the processor 14 calculates a position or a position variation of the object 2 with respect to the touch surface 10 according to detected frames F generated by the sensor 12 successively detecting the object 2. A cursor on a display device (not shown) correspondingly moves according to the position or the position variation.

The touch control system 1 of the present embodiment is a capacitive touch screen. Thus, the touch control system 1 is directly disposed on the display device, but the present disclosure is not limited thereto. In other embodiments, the touch control system 1 is a touch panel, a navigation device, a cellphone or a computer system. In addition, the present disclosure is adaptable to devices capable of detecting a user's finger in contact with a screen or directly calculating coordinates of a cursor, such as a finger navigation device, a mouse or an optical touch panel, but not limited to the capacitive touch screen. It should be mentioned that if the touch control system 1 is provided without any display function but further corresponding to a display device, e.g. a touch panel, the touch control system 1 preferably has an identical shape with the display device, but not limited thereto.

Referring to FIG. 2A continuously, the touch surface 10 is configured for an object 2 operating thereon. Since the touch control device 1 of the present embodiment is described by a capacitive touch screen as an example, the touch surface 10 preferably corresponds to a display device so that a user real-timely watches a position of a cursor corresponding to the object 2 through the display device. The touch surface 10 is a surface of an appropriate object.

The sensor 12 is configured to successively output detected frames F associated with the touch surface 10. It is appreciated that since the touch surface 10 has a periphery 10a, borders of the detected frame F are corresponding to the periphery 10a. In the present embodiment, the sensor 12 is disposed below the touch surface 10, as shown in FIG. 2A, but not limited thereto. The relative position between the sensor 12 and the touch surface 10 is determined according to actual applications.

It should be mentioned that the sensor 12 is a capacitive touch sensor, wherein the capacitive touch sensor has a plurality of detection units. When the object 2 contacts the touch surface 10, the detection units under the object 2 and around the object 2 correspondingly generate the capacitance variation, and then the sensor 12 outputs a detected frame F, but the present disclosure is not limited thereto. In other embodiments, the sensor 12 is a resistive touch sensor or an optical touch sensor.

The principles and structures of the capacitive touch sensor, resistive touch sensor and optical touch sensor mentioned above are well known, and thus details thereof are not described herein. It is to post process the detected frames outputted by the sensor 12 and determine whether to trigger edge swipe gestures in the present disclosure. In addition, the material of the object 2 is not particularly limited but determined according to the type of the sensor 12. For example, when the sensor 12 is a capacitive touch sensor, the object 2 is preferably a finger or a capacitive touch pen. When the sensor 12 is an optical touch sensor, the object 2 preferably has light blocking characteristics.

The processor 14 is, for example, a digital signal processor (DSP) or other processing devices for processing the detected frame F, and the processor 14 records first information of the object 2 leaving the touch surface 10 via the periphery 10a and second information of the object 2 entering the touch surface 10 via the periphery 10a according to the detected frames F, and determines whether to trigger an edge swipe gesture accordingly. In the present embodiment, the processor 14 is implemented by hardware. In other embodiments, t he processor 14 is integrated into software, e.g. an operating system or a predetermined program, or implemented by firmware.

FIG. 2B is a flow chart of a method for preventing accidentally triggering edge swipe gestures according to the first embodiment of the present disclosure, which is adapted to a touch control system including a touch surface, and the method includes the following steps of: recording first information when a first gesture is detected to end at a periphery of the touch surface (step S11); recording second information when a second gesture is detected to start at the periphery of the touch surface (step S12); and determining, by a processor, whether to trigger an edge swipe gesture according to the first information and the second information (step S13), wherein the first gesture occurs previous to the second gesture.

It should be mentioned that the processor 14 calculates the first gesture and the second gesture according to the detected frames F associated with the object 2 successively outputted by the sensor 12. That is to say, the first gesture and the second gesture represent position variations (i.e. traces) of the object 2 moving on the touch surface 10. For example, in the present embodiment, the first gesture ended at the periphery 10a of the touch surface 10 represents that the object 2 leaves the touch surface 10 via the periphery 10a; and the second gesture started at the periphery 10a of the touch surface 10 represents that the object 2 enters the touch surface 10 via the periphery 10a, but the present disclosure is not limited thereto. The method for the processor 14 to identify whether the object 2 leaves or enters the touch surface 10 via the periphery 10a according to the detected frames F is well known, and thus details thereof are not described herein.

Referring to FIGS. 2A and 2B together, details of the present embodiment are described hereinafter.

Step S11: Firstly, after the touch control system 1 is activated (i.e. initialization), a user moves the object 2 on the touch surface 10, and the sensor 12 successively outputs associated detected frames F to the processor 14. When a first gesture is detected to end at the periphery 10a of the touch surface 10 according to the detected frames F, the processor 14 then records first information.

Step S12: Then, when a second gesture is detected to start at the periphery 10a of the touch surface 10 according to the detected frames F, the processor 14 then records second information.

It is appreciated that the touch control system 1 or the processor 14 may further include a memory unit (not shown) configured to record the first information and the second information, and the processor 14 directly accesses the memory unit at any time. In the present embodiment, the memory unit respectively records one set of first information and one set of second information.

For example, when an object leaving the touch surface 10 via the periphery 10a is detected, the processor 14 records first information and overwrites the first information of a previous object leaving the touch surface 10 via the periphery 10a. Similarly, when the object entering the touch surface 10 via the periphery 10a is detected. the processor 14 records second information and overwrites the second information of the previous object entering the touch surface 10 via the periphery 10a. That is to say, the processor 14 records the latest first information and second information into the memory unit, but the present disclosure is not limited thereto. The recorded information may be determined according to the type and capacity of the memory unit. In another embodiment, for example the processor 14 records only the first information into the memory unit and the detected second information is directly calculated with the first information but not recorded in the memory unit.

Step S13: Finally, the processor 14 determines whether to trigger an edge swipe gesture according to the first information and the second information.

In a first aspect, the first information contains a first time and the second information contains a second time. When a time difference between the Oct time and the second time is smaller than a time threshold, the processor 14 does not trigger the edge swipe gesture; whereas when the time difference exceeds the time threshold, the processor 14 then triggers the edge swipe gesture. Accordingly, the processor 14 determines whether to trigger the edge swipe gesture according to the time difference. For example, the time threshold is previously stored as 500 ms before shipment of the touch control system 1, and the processor 14 determines whether to stop triggering the edge swipe gesture according to a comparison result between the time difference and the time threshold.

It should be mentioned that the time threshold is determined according to the size of the touch surface 10, application of the touch control system 1 or a predetermined program executed in the touch control system 1. The time threshold is not limited to a fixed value.

In a second aspect, in addition to the first time and the second time, the first information further includes a first position and the second information further includes a second position. The processor 14 calculates a distance between the first position and the second position according to the positions. When the time difference is smaller than a time threshold and the distance is smaller than a distance threshold. the processor 14 does not trigger the edge swipe gesture; whereas when the time difference exceeds the time threshold or the distance exceeds the distance threshold, the processor 14 triggers the edge swipe gesture.

It is appreciated that since the time difference and the distance are both considered in the second aspect of the touch control system 1 so as to determine whether to prevent triggering the edge swipe gesture. a judgment condition of the second aspect of the touch control system 1 is stricter than that of the first aspect of the touch control system 1, as shown in FIG. 3.

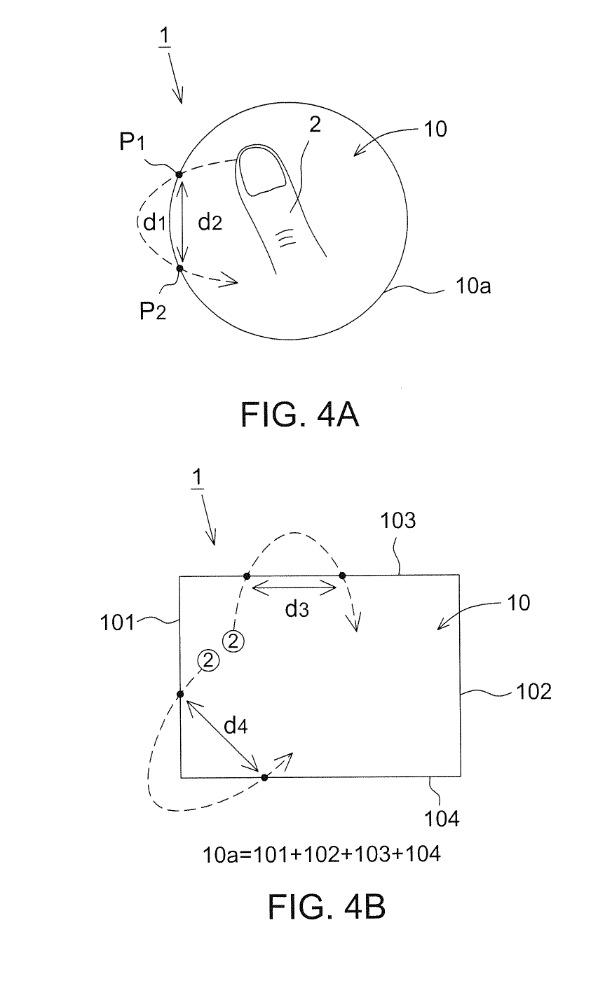

It should be mentioned that the method for calculating the distance between the first position and the second position is previously stored in the processor 14 before shipment of the touch control system 1. For example, referring to FIG. 4A, the finger 2 respectively leaves the touch surface 10 from a position P1 at the periphery 10a and then enters the touch surface 10 from a position P2 at the periphery 10a along the dotted line in the figure. The processor 14 calculates a pixel distance d1 or d2 between the positions P1 and P2 according to the detected frames F, wherein the pixel distance d1 indicates a distance between the positions P1 and P2 along the periphery 10a; and the pixel distance d2 indicates a linear distance between the positions P1 and P2.

In addition, if the touch surface 10 is not circular. Referring to FIG. 4B, the touch surface 10 is for example rectangular and has at least two edges, e.g. four edges 101, 102, 103 and 104 shown herein. When the object 2 leaves and enters the touch surface 10 via an identical edge (e.g. the edge 103), the processor 14 calculates a distance d3; whereas when the object 2 leaves and enters the touch surface 10 via two adjacent edges (e.g. the edges 101 and 104) respectively, the processor 14 calculates a distance d4. Therefore, when the periphery 10a has at least two edges, the distance is a pixel distance between positions at an identical edge or at two adjacent edges.

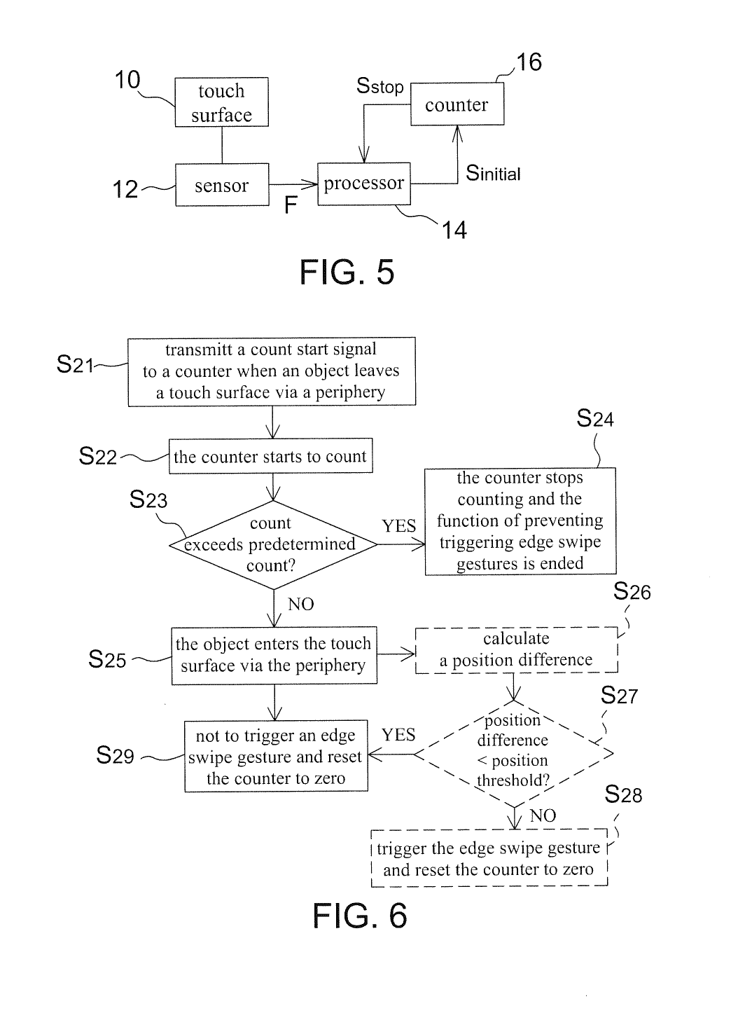

FIG. 5 is a block diagram of a touch control system 1 for preventing accidentally triggering edge swipe gestures according to a second embodiment of the present disclosure, and a schematic diagram thereof is representable by FIG. 2A. The touch control system 1 includes a touch surface 10, a sensor 12, a processor 14 and a counter 16. The sensor 12 and the counter 16 are electrically connected to the processor 14 respectively. Similarly, a user touches the touch surface 10 with an object 2. The processor 14 calculates a position or a position variation of the object 2 with respect to the touch surface 10 according to detected frames F generated by the sensor 12 successively detecting the object 2.

The touch surface 10 has a periphery 10a, and the sensor 12 is configured to successively output detected frames F associated with the touch surface 10. It is similar to the touch control system 1 of the first embodiment, and thus details thereof are not described herein.

The processor 14 is configured to identify whether the object 2 leaves or enters the touch surface 10 according to the detected frames F. When identifying that the object 2 leaves the touch surface 10 through the periphery 10a, the processor 14 transmits a count start signal Sᵢₙᵢₜᵢₐₗ to the counter 16.

The counter 16 is configured to start to count when receiving the count start signal Sᵢₙᵢₜᵢₐₗ. When a predetermined count is counted, the counter 16 transmits a count stop signal Sₛₜₒₚ to the processor 14. When the counter 16 transmits the count stop signal Sₛₜₒₚ or the processor 14 identifies the object 2 entering the touch surface 10 via the periphery 10a, the processor 14 resets the counter 16 to zero. Accordingly, when identifying that the object 2 enters the touch surface 10 via the periphery 10a, the processor 14 determines whether to trigger an edge swipe gesture according to the count stop signal Sₛₜₒₚ.

Referring to FIGS. 2A, 5 and 6 together, details of the present embodiment are described hereinafter, wherein FIG. 6 is a flow chart of a method for preventing accidentally triggering edge swipe gestures according to the second embodiment of the present disclosure.

Step S21: Firstly, after the touch control system 1 is activated (i.e. initialization), a user moves the object 2 on the touch surface 10. The sensor 12 successively outputs associated detected frames F to the processor 14. When identifying that the object 2 leaves the touch surface 10 from the periphery 10a, the processor 14 transmits a count start signal Sᵢₙᵢₜᵢₐₗ to the counter 16.

Step S22: After receiving the count start signal Sᵢₙᵢₜᵢₐₗ, the counter 16 starts to count.

In a first aspect, before the counter 16 stops counting (i.e. the count not exceeding a predetermined count), the processor 14 does not receive the count stop signal Sₛₜₒₚ transmitted from the counter 16. Therefore, when the processor 14 identifies that the object 2 enters the touch surface 10 from the periphery 10a before receiving the count stop signal Sₛₜₒₚ, the edge swipe gesture is not triggered, as in t he steps S23, S25 and S29. Meanwhile, the processor 14 resets the counter 16 to zero.

In a second aspect, after the counter 16 stops counting (i.e. the count exceeding the predetermined count), the processor 14 has received the count stop signal Sₛₜₒₚ transmitted from the counter 16. Therefore, when the processor 14 identifies that the object 2 enters the touch surface 10 from the periphery 10a and the count stop signal Sₛₜₒₚ is received, the edge swipe gesture is then triggered, as in the steps S23 and S24. Meanwhile, the processor 14 resets the counter 16 to zero.

That is to say, when an object is detected to leave the touch surface 10 from the periphery 10a and the count stop signal Sₛₜₒₚ is not received by the processor 14, the edge swipe gesture is continuously stopped being triggered; whereas when an object is detected to leave the touch surface 10 from the periphery 10a and the count stop signal Sₛₜₒₚ has been received by the processor 14, the function of preventing triggering edge swipe gestures is then ended.

Similar to the first embodiment, the processor 14 further records positions where the object 2 leaves and enters the touch surface 10 via the periphery 10a. Therefore, the processor 14 determines whether to trigger the edge swipe gesture according to both the count stop signal Sₛₜₒₚ and a distance between the positions (i.e. position difference), as in the steps S26-S29.

For example, in the first aspect of the second embodiment, when the processor 14 identifies that the object 2 enters the touch surface 10 from the periphery 10a and the processor 14 does not receive the count stop signal Sₛₜₒₚ transmitted from the counter 16; meanwhile, if the distance is smaller than a distance threshold, the edge swipe gesture is not triggered by the processor 14, as in the steps S27 and S29. However, if the processor 14 does not receive the count stop signal Sₛₜₒₚ and the distance exceeds a distance threshold, the edge swipe gesture is still triggered by the processor 14, as in the steps S27 and S28.

In addition, when an object is detected to leave the touch surface 10 from the periphery 10a and the stop count signal Sₛₜₒₚ is received by the processor 14, the distance is not necessary to be calculated.

As mentioned above, the touch control system 1 or the processor 14 further includes a memory unit configured to record the positions, and the processor 14 directly accesses the memory unit at any time so as to calculate the distance.

Similarly, the method for calculating the distance is described in the first embodiment of the present disclosure. In addition, when the periphery 10a includes at least two edges, the distance is a pixel distance between positions at an identical edge or at two adjacent edges.

In the present embodiment, the processor 14 transmits a count start signal Sᵢₙᵢₜᵢₐₗ to the counter 16 when identifying that the object 2 leaves the touch surface 10 from the periphery 10a. In other embodiments, the processor 14 transmits the count start signal Sᵢₙᵢₜᵢₐₗ only when a predetermined program is executed in the touch control system 1.

For example, the touch control system 1 may be a portable electronic device, e.g. a tablet computer, a smart phone or a handheld game console. When a user performs webpage browsing or word processing by using the portable electronic device, a finger or a touch pen used by the user may not be operated so fast on a touch surface of the portable electronic device that an edge swipe gesture is accidentally triggered. At this time, even if the finger or the touch pen is detected to leave the touch surface through a periphery by the processor 14, a count start signal Sᵢₙᵢₜᵢₐₗ is not transmitted to the counter 16. However, if a game program is executed in the portable electronic device and when the finger or the touch pen is detected to leave the touch surface through the periphery by the processor 14, the processor 14 transmits the count start signal Sᵢₙᵢₜᵢₐₗ to the counter 16 so that the portable electronic device is able to prevent accidentally triggering the edge swipe gesture due to the fast operation by the user. That is to say, in the present disclosure whether to activate the method for preventing accidentally triggering edge swipe gestures is determined according to the currently executed program.

The touch surface 10 of the touch control system 1 in the present embodiment is provided for a finger of a user to operate thereon, and thus the touch surface 10 may be defined as a touch operation area. In some embodiments, the present disclosure is adaptable to a window system. For example, the user uses a mouse or other navigation devices to operate in a cursor operation area of the window system, but not limited thereto.

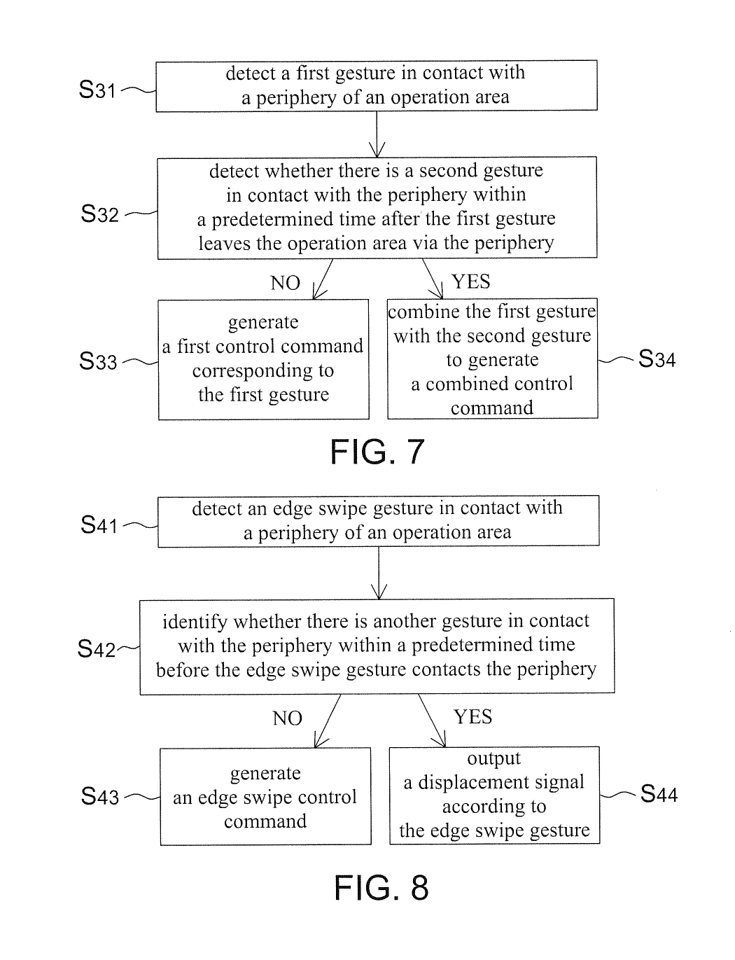

Referring to FIGS. 2A, 4A and 7 together. wherein FIG. 7 is a flow chart of a triggering method by gestures according to a third embodiment of the present disclosure. The triggering method in the present disclosure is configured to confirm that a gesture leaving a periphery of a touch operation area is not caused accidentally by waiting for a predetermined time.

Step S31: Firstly, when a finger 2 is operating on a touch surface 10 and moving outward, e.g. the finger 2 in FIG. 4A moving from the touch surface 10 to the position P1. a sensor 12 detects a first gesture in contact with a periphery 10a of the touch surface 10 (i.e. an operation area). It is appreciated that in FIG. 4A the trace before the finger 2 moving toward the position P1 at the periphery 10a is referred to a first gesture, and the trace after the finger 2 moving from the position P2 at the periphery 10a is referred to a second gesture.

Step S32: After the first gesture leaves the operation area from the periphery 10a, the sensor 12 keeps on detecting whether there is a second gesture in contact with the periphery 10a within a predetermined time, wherein the processor 14 identifies whether a time starting from the first gesture leaving the operation area till the second gesture occurs exceeds the predetermined time through a counter (e.g. the counter 16 of the second embodiment in the present disclosure) or other timing methods. In addition, the predetermined time may be a predetermined value (e.g. 500 ms) or adjustable by a user.

Step S33: Then, when the second gesture is not detected within the predetermined time, a first control command corresponding to the first gesture is generated, wherein the first control command is configured to activate an operation or a movement corresponding to the first gesture. For example, the operation corresponding to the first gesture is adjusting screen brightness, volume level or turning page up/down; and a trace corresponding to the first gesture is outputted according to the movement corresponding to the first gesture. In addition, the first gesture may not be completed when the finger 2 leaves the operation area from the periphery 10a in the step S31, and then when the second gesture is not detected within the predetermined time in the step S33, the first control command corresponding to the first gesture is not generated.

That is to say, when the first gesture of the present embodiment ends after contacting the periphery 10a, the corresponded first control command is not generated immediately. The processor 14 waits for a predetermined time and confirms no associated second gesture entering the operation area within the predetermined time, and the first control command is then generated. In addition, after generating the first control command (i.e. after the predetermined time), the processor 14 detects the second gesture, which is configured to, for example, trigger an edge swipe command.

Step S34: However, if the second gesture is detected within the predetermined time, the first gesture and the second gesture may be combined to generate a combined control command. At this time, the combined control command is configured to activate an operation or a movement corresponding to the first gesture combined with the second gesture. It is appreciated that the second gesture is not configured to trigger the edge swipe command when gestures combination is performed.

For example, it is assumed that the operation area is a browser window. The Oct control command activates an operation of “previous page” and the combined control command activates an operation of “reload”, but not limited thereto. The activated operation is determined according to the actual application.

As mentioned in the first embodiment of the present disclosure, the processor 14 further records a first position (e.g. the position P1) where the first gesture leaves the periphery 10a and a second position (e.g. the position P2) where the second gesture enters the periphery 10a and triggers a command accordingly. The processor 14 further generates the first control command corresponding to the first gesture, the combined control command or a second control command corresponding to the second gesture according to whether a distance between the first position and the second position (e.g. the distance d1 or d2) exceeds a distance threshold. For example. when the distance exceeds a distance threshold, the processor 14 successively generates the first control command and the second control command; whereas when the distance is smaller than the distance threshold, the processor 14 combines the first gesture with the second gesture to generate the combined control command.

Referring to FIGS. 2A, 4A and 8 together, wherein FIG. 8 is a flow chart of a method for triggering edge swipe gestures according to a fourth embodiment of the present disclosure. The method in the present disclosure is also configured to confirm that a gesture leaving a periphery of a touch operation area is not caused accidentally by confirming other gestures within a previous predetermined time.

Step S41: Firstly, a sensor 12 detects an edge swipe gesture in contact with a periphery 10a of an operation area (i.e. the touch surface 10), e.g., the finger 2 of FIG. 4A moving inward of the touch surface 10 from the position P2 at the periphery 10a. It should be mentioned that the edge swipe gesture of the present disclosure is a gesture entering the operation area from the periphery 10a or swiping at the periphery 10a, and the edge swipe gesture is corresponding to a pull down menu, volume level adjustment, screen brightness adjustment or the like, but not limited thereto. The function is determined according to the application of a touch control system or a window system.

Step S42: Then, the processor 14 identifies whether there is another gesture in contact with the periphery 10a within a predetermined time before the edge swipe gesture contacts the periphery 10a.

Steps S43-S44: When there is no other gesture in contact with the periphery 10a within a predetermined time before the edge swipe gesture contacts the periphery 10a, the processor 14 generates an edge swipe control command. Otherwise, if another gesture in contact with the periphery 10a is detected within the predetermined time, the processor 14 outputs a displacement signal according to the edge swipe gesture without generating the edge swipe control command.

The difference between the present embodiment and the third embodiment of the present disclosure is that the processor 14 of the present disclosure preferably includes a temporary storage unit or a buffer unit configured to record whether there is another gesture in contact with the periphery 10a within the predetermined time. For example, when the sensor 12 detects a previous gesture in contact with the periphery 10a, the previous gesture is stored in a temporary storage unit of the processor 14 and kept for a time. When the time exceeds the predetermined time, information of the previous gesture is removed. Therefore, the processor 14 finds no record associated with the previous gesture in the temporary storage unit in the step S43 such that the edge swipe control command is triggered according to the edge swipe gesture.

As mentioned in the first embodiment of the present disclosure, the processor 14 further records a first position of the edge swipe gesture corresponding to the periphery 10a. When a previous gesture in contact with the periphery 10a is detected within the predetermined time, a second position of the previous gesture corresponding to the periphery 10a is recorded. Thus, the processor 14 further determines whether to generate the edge swipe control command according to a distance between the first position and the second position. For example, when the distance exceeds the distance threshold, the processor 14 generates the edge swipe control command; whereas when the distance is smaller than the distance threshold, the processor 14 combines the edge swipe gesture with the previous gesture to form a continuous gesture and does not generate the edge swipe control command.

As mentioned above, the conventional touch control system does not have the function of preventing accidentally triggering an edge swipe gesture. Therefore, the present disclosure provides a method for preventing accidentally triggering edge swipe gestures that determines whether to prevent accidentally triggering edge swipe gestures according to a time difference and/or a distance difference between the object leaving and entering a touch surface via a periphery so as to provide better user experience.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A method for preventing accidentally triggering edge swipe gestures, adapted to a touch control system comprising a touch surface, the method comprising:
recording first information when a first gesture is detected to end at a periphery of the touch surface;
recording second information when a second gesture is detected to start at the periphery of the touch surface; and
determining, by a processor, whether to trigger an edge swipe gesture of the touch control system according to the first information and the second information.

2. The method as claimed in claim 1, wherein the first information comprises a first time and the second information comprises a second time, and the processor determines whether to trigger the edge swipe gesture according to a time difference between the first time and the second time.

3. The method as claimed in claim 2, further comprising:
not triggering the edge swipe gesture when the time difference is smaller than a time threshold; and
triggering the edge swipe gesture when the time difference exceeds the time threshold.

4. The method as claimed in claim 2. wherein the first information further comprises a first position and the second information further comprises a second position, and the processor determines whether to trigger the edge swipe gesture according to the time difference and a distance between the first position and the second position.

5. The method as claimed in claim 4, further comprising:
not triggering the edge swipe gesture when the time difference is smaller than a time threshold and the distance is smaller than a distance threshold; and
triggering the edge swipe gesture when the time difference exceeds the time threshold or the distance exceeds the distance threshold.

6. The method as claimed in claim 4, wherein the periphery comprises at least two edges, and the distance is a pixel distance between positions at an identical edge or at two adjacent edges.

7. A triggering method by gestures, adapted to a window system comprising an operation area, the triggering method comprising:
detecting a first gesture in contact with a periphery of the operation area;
detecting whether there is a second gesture in contact with the periphery within a predetermined time after the first gesture leaves the operation area from the periphery; and
generating a first control command corresponding to the first gesture when the second gesture is not detected within the predetermined time.

8. The triggering method as claimed in claim 7, wherein the first control command is configured to activate an operation or a movement corresponding to the first gesture.

9. The triggering method as claimed in claim 7, further comprising:
combining the first gesture with the second gesture to generate a combined control command when the second gesture is detected within the predetermined time.

10. The triggering method as claimed in claim 9, wherein the combined control command is configured to activate an operation or a movement corresponding to the first gesture combined with the second gesture.

11. The triggering method as claimed in claim 7, further comprising:
recording a first position where the first gesture leaves the periphery; and
recording a second position where the second gesture enters the periphery when the second gesture is detected within the predetermined time.

12. The triggering method as claimed in claim 11, further comprising:
successively generating the first control command corresponding to the first gesture and a second control command corresponding to the second gesture when a distance between the first position and the second position exceeds a distance threshold; and
combining the first gesture with the second gesture to generate a combined control command when the distance between the first position and the second position is smaller than the distance threshold.

13. The triggering method as claimed in claim 7, wherein the operation area is a cursor operation area or a touch operation area of the window system.

14. A triggering method by gestures, adapted to a window system comprising an operation area, the triggering method comprising:
detecting an edge swipe gesture in contact with a periphery of the operation area; and
generating an edge swipe control command when there is no gesture in contact with the periphery within a predetermined time before the edge swipe gesture contacts the periphery.

15. The triggering method as claimed in claim 14, further comprising:
outputting a displacement signal according to the edge swipe gesture but not generating the edge swipe control command when another gesture in contact with the periphery is detected within the predetermined time.

16. The triggering method as claimed in claim 14, further comprising:
combining the edge swipe gesture with a previous gesture to form a continuous gesture but not generating the edge swipe control command when the previous gesture in contact with the periphery is detected within the predetermined time.

17. The triggering method as claimed in claim 14, further comprising:
calculating a distance between a first position of the edge swipe gesture corresponding to the periphery and a second position of a previous gesture corresponding to the periphery when the previous gesture in contact with the periphery is detected within the predetermined time.

18. The triggering method as claimed in claim 17, further comprising:
generating the edge swipe control command when the distance exceeds a distance threshold; and
combining the edge swipe gesture with the previous gesture to form a continuous gesture but not generating the edge swipe control command when the distance is smaller than the distance threshold.

19. The triggering method as claimed in claim 14, wherein the edge swipe gesture is a gesture entering the operation area through the periphery or a gesture swiping at the periphery.

20. The triggering method as claimed in claim 14, wherein the operation area is a cursor operation area or a touch operation area of the window system.
